(19) United States
(12) Patent Application Publication
(10) Pub. No.: US 2026/0057550 A1
(43) Pub. Date: Feb. 26, 2026

(54) SYSTEMS AND METHODS FOR TARGETLESS SENSOR CALIBRATION

(71) Applicant: Stack AV Co., Mount Pleasant, PA (US)

(72) Inventors: Nicholas Giovanni CORSO, Seattle, WA (US); Hatem ALISMAIL, Pittsburgh, PA (US)

(73) Assignee: Stack AV Co., Mount Pleasant, PA (US)

(21) Appl. No.: 18/812,327

(22) Filed: Aug. 22, 2024

(51) Int. Cl. G06T 7/80; G01S 17/86; G06V 10/75; G06V 20/56

(52) U.S. Cl. CPC G06T 7/80; G01S 17/86; G06V 10/757; G06V 20/56

(57) ABSTRACT

A sensor calibration system of a vehicle is provided, comprising an optical sensor configured to generate two-dimensional optical calibration data and a LiDAR sensor configured to generate three-dimensional intensity calibration data. The system extracts one or more optical images from the optical calibration data and projects one or more portions of the intensity calibration data onto one or more optical image planes corresponding to the one or more optical images to form one or more intensity images. The system detects a set of points in the one or more intensity images and another set of points in the one or more optical images corresponding to one or more environmental features. The system creates a plurality of pairings wherein each pairing comprises corresponding points from the two sets of points and computes an alignment between the optical sensor and the LiDAR sensor based on a subset of the plurality of pairings.

### FIELD

The present disclosure relates generally to systems and methods for targetless sensor calibration, and more specifically to optical and LiDAR sensor calibration.

### BACKGROUND

Sensors such as optical sensors or cameras and LiDAR sensors may be used on autonomous or semi-autonomous vehicles to enable autonomous control and driver awareness. Uncertainties or mounting tolerances affecting the orientation and position of such sensors may introduce difficulties when attempting to use data from multiple sensors detecting some or all of the same features. Such uncertainties may be reduced by calibrating one sensor with respect to another, thereby fusing sensor information, providing a vehicle control system multiple perspectives and/or depth information on nearby detected objects. Known techniques for calibrating optical sensors and LiDAR sensors on autonomous or semi-autonomous vehicles may require use of a ground-truth target with a known pattern or use of depth discontinuities such as edges in the natural features of a vehicle's surroundings. Ground-truth targets may require careful placement at a distance that matches both optical and LiDAR sensors, which may have different fields-of-view, and in an uncluttered environment which particular illumination requirements. Further, target material selection and pattern design may be constrained by requirements derived from both sensing modalities, e.g. a high-contrast checkerboard that may be ideal for an optical sensor may increase noise in LiDAR intensity data. Target size may also need to be scaled with vehicle size, meaning a target for calibration of sensors on a semi-truck may be substantially larger than that required for calibration of sensors on a passenger vehicle. Should a set of sensors need to be recalibrated, use of a target-based method may necessitate returning a vehicle to its original calibration location.

In place of a ground-truth target, calibration based on known techniques may involve aligning depth discontinuities in LiDAR data to edge features in a natural scene surrounding the vehicle. Alignment quality between depth discontinuities and edge features may be affected by the spacing between the LiDAR and optical sensors and distance from the sensor to each feature. An object close to the vehicle, for example, may appear different from the perspective of one sensor relative to the other, and may also occlude part of the scene for one sensor but not for the other. Further, aligning depth discontinuities and edge features may require non-linear optimization techniques may in turn require a sufficiently close initial estimate of the calibration or alignment, e.g. the difference in pose between the sensors being calibrated, to produce an accurate calibration solution. Other calibration targetless techniques may project three-dimensional LiDAR data into a two-dimensional surface that doesn't match the optical image data, introducing complexities or errors when matching features between the datasets.

### SUMMARY

Described herein are systems and methods for an improved targetless calibration of optical and LiDAR sensors, enabling sensor fusion on autonomous or semi-autonomous vehicles. Unlike target-based calibration systems, systems and methods disclosed may include only natural texture and three-dimensional objects commonly found in the vicinity of automobiles including, for example, trees, poles, rocks, and parked cars. Disclosed systems and methods may accept a wide range of initial estimates of the calibration or alignment, e.g. the difference in position and orientation between two sensors, and may compute a final alignment solution by simultaneously and accurately matching features between LiDAR intensity images and one or more optical images extracted from optical data that may contain lens distortion associated with wide field-of-view optical sensors.

The disclosed targetless calibration systems may first preprocess optical calibration data generated by an optical sensor by extracting one or more optical images from the data. In the case of a wide field-of-view sensor, preprocessing may involve reducing or eliminating lens distortion and extracting two or more optical images corresponding to rotated views that may capture the field-of-view of the sensor. An exemplary system may further preprocess three-dimensional intensity calibration data, which may be in the form of a low-density point cloud, by accumulating one or more seconds of intensity data while the vehicle is in motion, relating it to a period when the vehicle is stationary, thereby generating densified intensity data temporally synchronized to optical data. Systems disclosed herein may generate an estimate of the alignment between an optical sensor and a LiDAR sensor and use the estimate to transform intensity calibration data corresponding to the extracted optical images from the coordinate system of the LiDAR sensor to that of the optical sensor. This three-dimensional intensity data may then be projected onto an image plane of the optical sensor or a rotated view derived therefrom, to form one or more intensity images with a field-of-view that may match that of a corresponding extracted optical image. Projection of the intensity data may involve mapping each point of three-dimensional intensity data in the form of a point cloud onto the image plane of the optical sensor or a rotated view derived therefrom using parameters of the optical sensor and/or rotated view. By optionally forming optical images with reduced distortion and intensity images that correspond in projection and field-of-view to said optical images, disclosed systems, unlike known techniques, may enable use of a wider range of feature detecting and matching capabilities that in turn improve efficiency and accuracy in alignment computation.

After preprocessing optical and intensity calibration data, an exemplary system may compute the alignment between an optical and a LiDAR sensor, or the transformation required to bring one sensor into alignment with the other. A system may first use a feature detector on one or more intensity images and optical images to identify sets of points of interest of environmental features in each image. These sets of points may be used as an input for a feature matcher that may create pairings of points in sets of images that may correspond to the same environmental feature. Points from each pairing of a subset of pairings may then be converted to vector form using intrinsic parameters of the optical sensor and/or depth information measured by the LiDAR sensor, and an alignment between the two sensors computed based on the subset. This alignment may be evaluated initially based on the proportion of the total number of pairings that satisfy agreement criteria with respect to the computed alignment with the process iterating based optionally on Random Sample Consensus or an alternative method until an alignment corresponding to a sufficiently high ratio is computed.

The alignment may be further evaluated by computing a set of reprojections errors measured after applying the alignment to transform intensity calibration data used to form the aforementioned point pairings. If a disclosed system comprises two or more optical sensors, alignment may additionally be evaluates by computing a set of epipolar errors between pairing points corresponding to two optical sensors each aligned to the same LiDAR sensor based on the above-described process. Once alignment evaluation is complete, disclosed systems may apply the computed sensor alignment or calibration by transforming data generated by one or more optical and/or LiDAR sensors thereby fusing sensor data and enabling augmentation of optical data with depth information while minimizing errors due to miscalibration or misalignment.

In some embodiments, a sensor calibration system of a vehicle is provided, the calibration system comprising an optical sensor configured to generate two-dimensional optical calibration data; a LiDAR sensor configured to generate three-dimensional intensity calibration data; and one or more computer-readable media storing instructions that, when executed by one or more processors, cause the system to generate optical calibration data and intensity calibration data; extract one or more optical images from the optical calibration data; project one or more portions of the intensity calibration data onto one or more optical image planes corresponding to the one or more optical images to form one or more intensity images; detect a first set of points in the one or more intensity images and a second set of points in the one or more optical images corresponding to one or more environmental features; create a plurality of pairings wherein each pairing comprises a first point from the first set of points and a corresponding second point from the second set of points; and compute an alignment between the optical sensor and the LiDAR sensor based on a subset of the plurality of pairings.

In some embodiments, generating the intensity calibration data further comprises accumulating one or more seconds of intensity calibration data while the vehicle is in motion. In some embodiments, accumulating one or more seconds of intensity calibration data comprises aligning, using an iterative closest point algorithm, the one or more seconds of intensity calibration data with a portion of the intensity calibration data captured before or after the one or more seconds of accumulation. In some embodiments, generating the intensity calibration data further comprises removing one or more segments from an intensity range of the intensity calibration data and performing histogram equalization on the intensity calibration data following removal of the one or more segments from the intensity range. In some embodiments, projecting the one or more portions of intensity calibration data onto the one or more optical image planes is based on an estimated alignment between the optical sensor and the LiDAR sensor. In some embodiments, forming the one or more intensity images comprises matching a field-of-view of the corresponding one or more optical images. In some embodiments, projecting the one or more portions of intensity calibration data comprises generating depth information for one or more datapoints of the one or more intensity images. In some embodiments, extracting one or more optical images from the optical calibration data comprises rotating two or more portions of the optical calibration data about a vertical axis of the optical sensor. In some embodiments, extracting one or more optical images further comprises reducing lens distortion in the optical calibration data. In some embodiments, the first point and the second point of each pairing of the plurality of pairings correspond to a common environmental feature of the one or more environmental features, and each pairing was generated using one or more feature-matching machine-learning algorithms. In some embodiments, creating the plurality of pairings comprises determining, based on the depth information, that an environmental feature of the one or more environmental features is occluded in at least one of: the one or more optical images or the one or more intensity images, and excluding one or more pairings from the plurality of pairings based on the determination. In some embodiments, computing the alignment between the optical sensor and the LiDAR sensor comprises using a Perspective-n-Point solver based on direction vectors. In some embodiments, the one or more optical images comprise two or more optical images, and the subset of the plurality of pairings is based on points in each of the two or more optical images. In some embodiments, the instructions further cause the system to determine a number of the plurality of pairings that satisfy one or more agreement criteria with respect to the alignment using Random Sample Consensus. In some embodiments, the instructions further cause the system to determine that a ratio between the determined number of pairings that satisfy the one or more agreement criteria and a total number of pairings meets a pairing threshold. In some embodiments, the instructions further cause the system to apply one or more transformations based on the alignment to the intensity calibration data corresponding to each pairing of the plurality of pairings to form transformed intensity pairing points; and project each transformed intensity pairing point onto a corresponding optical image plane of each pairing of the plurality of pairings to form a set of reprojected intensity pairing points. In some embodiments, the instructions further cause the system to compute a set of distances wherein each distance corresponds to a pairing of the plurality of pairings and represents a distance between a point from the set of reprojected intensity pairing points and a point from the second set of points in the one or more optical images. In some embodiments, the instructions further cause the system to determine that one or more distances in the set of distances meet a reprojection threshold. In some embodiments, the alignment is a first alignment, and the instructions further cause the system to compute a secondary alignment between a secondary optical sensor and the LiDAR sensor, and a field-of-view of the optical sensor overlaps a field-of-view of the secondary optical sensor. In some embodiments, the instructions further cause the system to detect a primary set of points in the one or more optical images and a secondary set of points in one or more secondary optical images of the secondary optical sensor corresponding to one or more environmental features; and apply one or more transformations based on the first alignment to the primary set of points and one or more transformations based on the secondary alignment to the secondary set of points. In some embodiments, the instructions further cause the system to compute a set of epipolar errors between one or more points of the primary set of points and one or more points of the secondary set of points. In some embodiments, the instructions further cause the system to determine that one or more of the epipolar errors in the set of epipolar errors meet an epipolar threshold. In some embodiments, the instructions further cause the system to apply one or more transformations based on the alignment to at least one of vehicle control optical data or vehicle control intensity data.

In some embodiments, a method for calibrating sensors of a vehicle is provided, the method performed by a system comprising memory and one or more processors, the method comprising generating optical calibration data and intensity calibration data; extracting one or more optical images from the optical calibration data; projecting one or more portions of the intensity calibration data onto one or more optical image planes corresponding to the one or more optical images to form one or more intensity images; detecting a first set of points in the one or more intensity images and a second set of points in the one or more optical images corresponding to one or more environmental features; creating a plurality of pairings wherein each pairing comprises a first point from the first set of points and a corresponding second point from the second set of points; and computing an alignment between the optical sensor and the LiDAR sensor based on a subset of the plurality of pairings.

In some embodiments, a non-transitory computer readable storage medium storing instructions for calibrating sensors of a vehicle is provided, wherein the instructions, when executed by one or more processors of an electronic device, cause the device to generate optical calibration data and intensity calibration data; extract one or more optical images from the optical calibration data; project one or more portions of the intensity calibration data onto one or more optical image planes corresponding to the one or more optical images to form one or more intensity images; detect a first set of points in the one or more intensity images and a second set of points in the one or more optical images corresponding to one or more environmental features; create a plurality of pairings wherein each pairing comprises a first point from the first set of points and a corresponding second point from the second set of points; and compute an alignment between the optical sensor and the LiDAR sensor based on a subset of the plurality of pairings.

In some embodiments, any of the features of any of the embodiments described above and/or described elsewhere herein may be combined, in whole or in part, with one another. Additional advantages will be readily apparent to those skilled in the art from the following figures and detailed description. The aspects and descriptions herein are to be regarded as illustrative in nature and not restrictive.

### BRIEF DESCRIPTION OF THE FIGURES

The patent or application file contains at least one drawing executed in color. Copies of this patent or patent application publication with color drawings will be provided by the Office upon request and payment of the necessary fee.

The invention will now be described, by way of example only, with reference to the accompanying drawings in which:

FIG. 1A depicts an exemplary system for generating an alignment between two sensors, according to some embodiments.

FIG. 1B depicts an exemplary placement of system components on a vehicle, according to some embodiments.

FIG. 1C depicts an exemplary process for generating an alignment between two sensors, according to some embodiments.

FIG. 2 depicts an exemplary extraction of three optical images from optical calibration data of a scene, according to some embodiments.

FIG. 3A depicts an exemplary intensity image of a scene without modification of the intensity range, according to some embodiments.

FIG. 3B depicts an exemplary intensity image of a scene with modification of the intensity range, according to some embodiments.

FIG. 4A depicts an exemplary optical image of a scene, according to some embodiments.

FIG. 4B depicts an exemplary intensity image of a scene, according to some embodiments.

FIG. 5A depicts an exemplary set of points corresponding to environmental features in an intensity image and an optical image of a scene, according to some embodiments.

FIG. 5B depicts an exemplary set of pairings of points corresponding to environmental features in an intensity image and an optical image of a scene, according to some embodiments.

FIG. 6A depicts a first exemplary process for evaluating alignment, according to some embodiments.

FIG. 6B depicts a second exemplary process for evaluating alignment, according to some embodiments.

FIG. 7A depicts an exemplary set of distances depicting alignment between two sensors before calibration, according to some embodiments.

FIG. 7B depicts an exemplary set of distances depicting alignment between two sensors after calibration, according to some embodiments.

FIG. 8A depicts an exemplary set of epipolar errors corresponding to a first optical sensor after calibration, according to some embodiments.

FIG. 8B depicts an exemplary set of epipolar errors corresponding to a second optical sensor after calibration, according to some embodiments.

FIG. 9 depicts an exemplary computing system, according to some embodiments.

### DETAILED DESCRIPTION

Accordingly, disclosed herein are systems and methods to enable calibration of optical and LiDAR sensors, in turn enabling fusion of sensor data on autonomous or semi-autonomous vehicles. To enable calibration, disclosed systems may process data from one or more optical sensors and one or more LiDAR sensors before computing and evaluating an alignment which may then be applied to control the vehicle to which the sensors are attached.

An exemplary system may include an optical sensor generating two-dimensional optical calibration data and a LiDAR sensor generating three-dimensional intensity calibration data or point cloud data. The system may apply image processing techniques and/or extract one or more optical images from the optical calibration data depending on, for example, the degree of lens distortion in the data and the field of view of the optical sensor. To process intensity calibration data, the system may accumulate intensity calibration data while the vehicle is in motion to densify the number of data points and/or modify the intensity range of the data to improve feature visibility in the range of interest. The system may then select one or more portions of the resulting intensity calibration data that correspond to the one or more optical images and make an initial estimate of the alignment between the optical sensor and LiDAR sensor. The system may then project, based on the initial alignment estimate, the selected portions of three-dimensional intensity data onto one or more optical image planes that may correspond to the one or more optical images, thereby forming one or more intensity images. This projection of the intensity data may refer to mapping each point of three-dimensional intensity point cloud data onto the image plane of the optical sensor or a rotated view derived therefrom using intrinsic parameters of the optical sensor and/or rotated view.

Once one or more intensity images that may correspond to one or more optical images have been formed, the system may next compute the alignment between the optical sensor and the LiDAR sensor. The system may first detect a set of points corresponding to environmental features in the both the one or more optical images and the one or more intensity images using, for example, a machine learning-based detector network. The system may then create a plurality of pairings or matches between the set of points in the one or more optical images and the one or more intensity images optionally using a machine learning-based feature matcher network. In this case, the point from the one or more optical images and the point from the one or more intensity images that together form each pair of points reference matching points on a feature detected by both sensors. The system may then compute an alignment, e.g. the rotation and/or translation, between the optical sensor and LiDAR sensor based on a subset of the plurality of pairings, optionally employing a Perspective-n-Point solver that employs direction vectors in combination with Random Sample Consensus used to iterate the solver and increase accuracy of the alignment computation.

To evaluate the accuracy of the alignment with each iteration of the solver, the system may compute the number of pairings that satisfy agreement criteria with respect to the computed alignment at that iteration, and a corresponding ratio between this number of pairings satisfying agreement criteria and the total number of pairings. If this ratio meets a pairing threshold, the system may perform one or more secondary alignment evaluations to confirm the accuracy of the alignment before optionally applying transformations that are based on the alignment to vehicle control optical data or vehicle control intensity data thereby fusing the two sensing modalities.

Systems and methods described herein may thus have several advantages over known techniques. For example, known targetless calibration techniques may rely on alignment of depth discontinuities or edge features and associated non-linear optimization techniques that require a close initial estimate of sensor alignment. Further, traditional feature detection solutions typically perform poorly when exposed to significant differences in scene illumination or sensing modality. By applying machine learning-based detector and feature matcher networks, the disclosed systems and methods may accept a wide range of initial alignment estimates and may establish robust feature pairings even across significant differences in detected images including those produced by optical and LiDAR sensors. Further, known techniques may not produce optical images from wide field-of-view optical sensors that match the intensity images from LiDAR sensors. That is, known techniques may simply project intensity calibration data onto a generic surface thereby creating an intensity image that may not match the parameters of optical images from wide field-of-view optical sensors, reducing the number and accuracy of feature matches used for calibration. Disclosed systems and methods may instead preprocess both intensity and optical data to minimize lens distortion that may accompany wide field-of-view optical sensors and thereby enable use of aforementioned machine learning-based detector and matcher networks for robust feature matching. Optical calibration data may be preprocessed by reducing lens distortion and/or extracting one or more optical images from the data, including multiple rotated views from a single wide field-of-view image. Intensity calibration data in the form of a point cloud may be preprocessed by projecting the data, point by point, onto one or more optical image planes associated with the one or more extracted optical images based on parameters of the optical sensor, thereby creating an intensity image with similar projection and field-of-view to that of each optical image. Known techniques may also not be able to compare intensity images with a plurality of extracted optical images simultaneously. By using direction vectors instead of pixel coordinates in the original image plane, disclosed systems and methods may simultaneously compute alignment solutions between a plurality of extracted optical images and corresponding intensity images.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed terms. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, storage medium, such as, but not limited to, any type of disk, including floppy disks, USB flash drives, external hard drives, optical disks, CD-ROMs, magneto-optical disks, read-only memories (ROMs), random access memories (RAMs), EPROMs, EEPROMs, magnetic or optical cards, application-specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear in the description below. In addition, the present invention is not described with reference to any particular programming language. It will be appreciated that a variety of programming languages may be used to implement the teachings of the present disclosure as described herein.

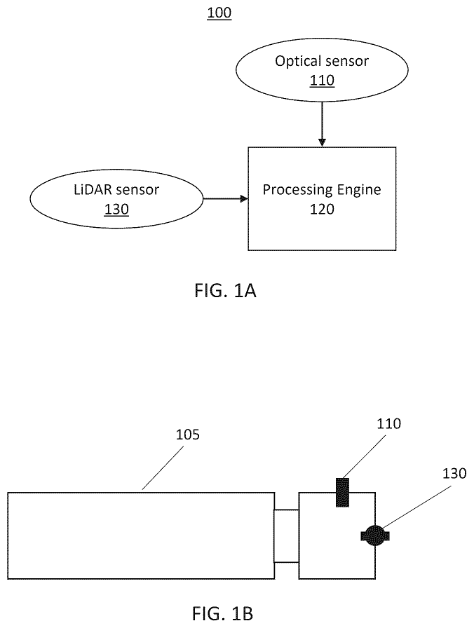

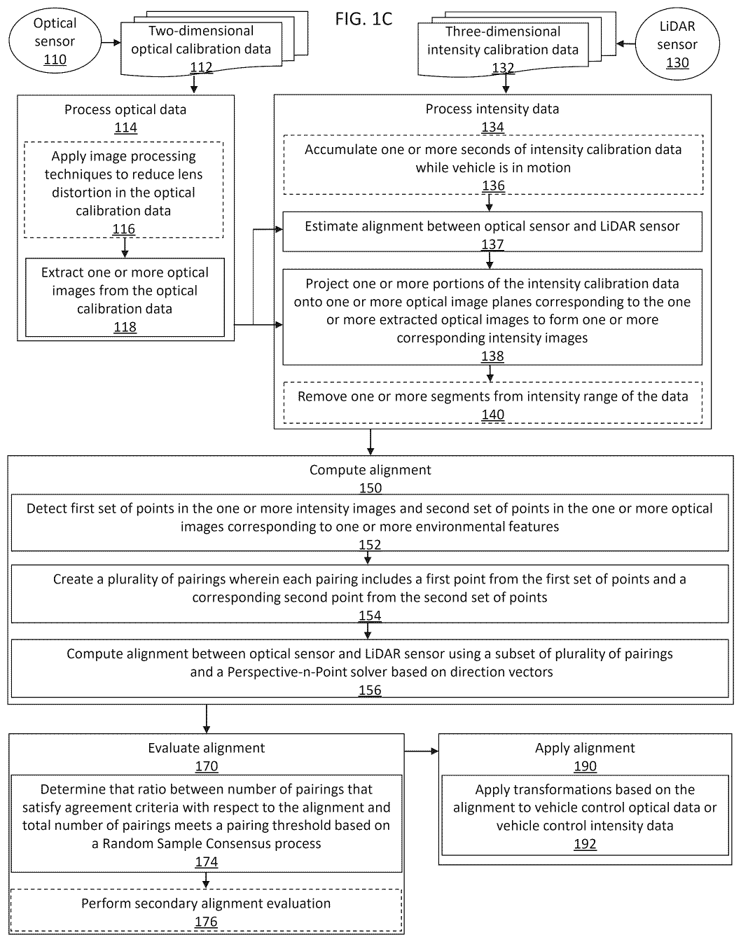

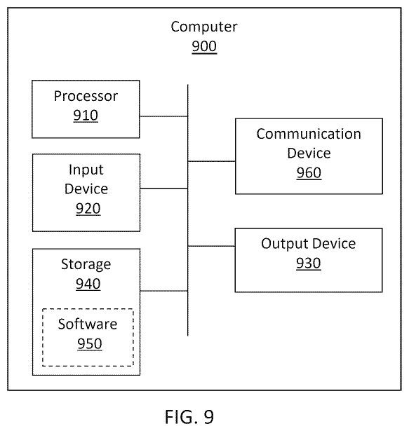

FIG. 1A depicts an exemplary system 100 that may be used to generate an alignment between sensors on an autonomous or semi-autonomous vehicle. The system may include an optical sensor 110, a LiDAR sensor 130, and a processing engine 120. Optical sensor 110 may include, for example, a standard field-of-view camera, a wide field-of-view camera or camera with a fisheye lens, for example based on photodiodes, phototransistors, charge-coupled devices, complementary metal-oxide-semiconductor sensors, and/or photoresistors. Optical sensor 110 may additionally or alternative include an infrared camera. The LiDAR sensor 130 may include, for example, a time-of-flight LiDAR sensor, a frequency-modulated continuous wave LiDAR sensor, a scanning LIDAR sensor, and/or a flash LIDAR sensor, and may or may not rotate to provide 360 degree detection of nearby objects. System 100 may optionally include one or more, two or more, three or more, or four or more optical sensors, which may include, for example, one or more of the types of optical sensors listed above. Said optical sensors may be mounted to a vehicle and may be, for example, forward-facing, rear-facing, and/or side-facing. System 100 optionally include one or more, two or more, three or more, or four or more LiDAR sensors, which may include, for example, one or more of the types of LiDAR sensors listed above. Processing engine 120 may include one or more processors, and may be configured to execute instructions stored in a memory or other computer-readable media to cause system 100 to process calibration data produced by optical sensor 110 and LiDAR sensor 130, compute an alignment between the two sensors, and/or evaluate the resulting alignment as described in further detail below. For example, processing engine 120 may include computer 900 as discussed in the context of FIG. 9.

FIG. 1B depicts an exemplary placement of sensors including optical sensor 110 and LiDAR sensor 130 on a vehicle, in this case semi-truck 105. In the exemplary configuration depicted, LiDAR sensor 130 is forward-facing while optical sensor 110 is side-facing. LiDAR sensor 130 and/or optical sensor 110 may be mounted in different configurations, with LiDAR sensor 130 and/or optical sensor 110 facing, for example, the front, the right side, the left side, and/or the rear of vehicle 105. System 100 may include one or more additional optical and/or LiDAR sensors which in turn may face, for example, the front, the right side, the left side, and/or the rear of vehicle 105.

FIG. 1C depicts an exemplary process by which system 100 may generate an alignment between an optical sensor 110 and a LiDAR sensor 130. Optical sensor 110, which may take the form, for example, of a camera with a standard or wide field-of-view, may produce two-dimensional optical calibration data 112. Optical calibration data 112 may take the form of one or more raw image files or combinations thereof and may include features from objects that are in the vicinity of a vehicle onto which optical sensor 110 is mounted. LiDAR sensor 130, which may take the form, for example, of a time-of-flight LiDAR sensor and may be rotating to provide 360-degree coverage, may produce three-dimensional intensity calibration data 132. Intensity calibration data 132 may take the form of a point cloud, wherein each “point” may represent an intensity of a reflected laser emission, and the distance from the sensor to the object off which the emission reflected, otherwise referred to as depth information.

System 100 may process optical calibration data 112 at step 114 by optionally applying one or more image processing techniques to reduce lens distortion in the optical calibration data at step 116 before extracting one or more optical images from the data at step 118. In the case of a standard field-of-view sensor producing relatively little lens distortion, for example, system 100 may extract a single optical image in the form of the raw image file without applying image processing techniques to correct lens distortion. In the case of a wide field-of-view sensor producing more significant lens distortion, for example, system 100 may apply one or more lens distortion correction algorithms to reduce any radial and/or tangential distortion present in the data before extracting one or more optical images. Extracted optical images may correspond to different regions of the raw image file that may form the optical calibration data. To extract multiple optical images, system 100 may create at least one, at least two, at least three, at least four, at least five at most nine, at most eight, and/or at most seven rotated views or virtual cameras aligned in different directions, for example representing rotations by −55 degrees, 0 degrees, and 55 degrees about the vertical axis of optical sensor 110. In some implementations, the rotated views or virtual cameras may represent rotations in one or more directions about the vertical axis of optical sensor 110 of at least 10 degrees, at least 20 degrees, at least 30 degrees, at least 40 degrees, at least 50 degrees, at least 60 degrees, at most 90 degrees, at most 80 degrees, at most 70 degrees, at most 60 degrees, at most 50 degrees, at most 40 degrees, and/or at most 30 degrees. System 100 may then project or map optical calibration data onto these rotated views thereby forming, in this example, three extracted or virtual optical images representing how the scene would look from various directions. By extracting multiple optical images from a dataset produced by a wide field-of-view sensor, system 100 may reduce parallax errors or occlusions that may arise when the optical sensor views an external object or feature at a separation from or a different angle than a LiDAR sensor or another optical sensor.

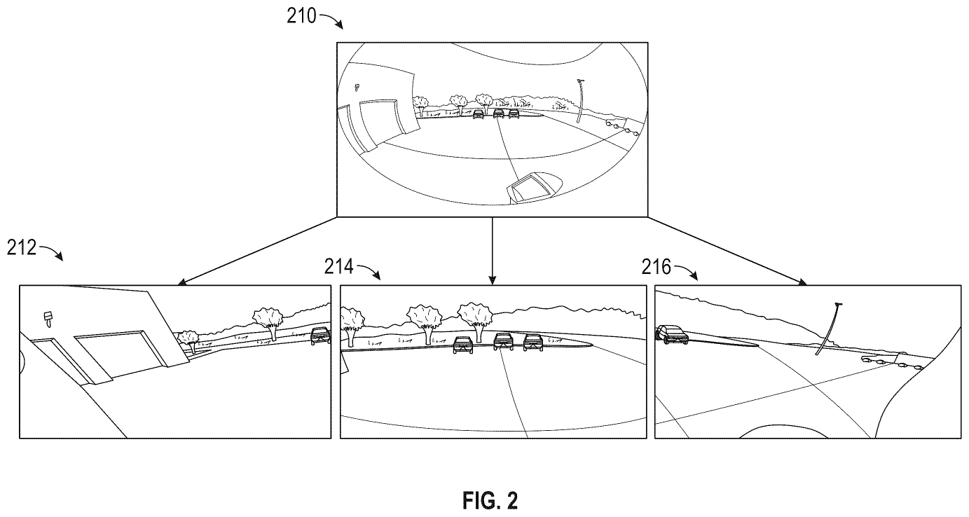

For example, in FIG. 2, image 210 represents an example of an optical image that may form optical calibration data captured by a wide field-of-view optical sensor and containing significant lens distortion. Images 212, 214, and 216 represent examples of optical images that the system may form by first applying image processing techniques to correct lens distortion before extracting multiple virtual optical images 212, 214, and 216 representing projection onto one or more rotated views or virtual cameras, in this case rotated 55 degrees, 0 degrees, and −55 degrees about the vertical axis of the optical sensor. That is, images 212, 214, and 216 each were extracted from, and correspond to different portions of, image 210.

At step 134 of FIG. 1, three-dimensional intensity calibration data 132 may be processed by optionally accumulating one or more seconds of intensity calibration data at step 136. In some embodiments, the intensity calibration data may be accumulated for at least one second, at least two seconds, at least three seconds, at least five seconds, at least ten seconds, at least 15 seconds, at least 20 seconds, at least 30 seconds, at most 60 seconds, at most 30 seconds, at most 20 seconds, at most 15 seconds, at most ten seconds, at most five seconds, at most three seconds, at most two seconds, and/or at most one second. Many types of LiDAR sensors, including those rotating to produce 360-degree coverage, may produce three-dimensional intensity calibration data in the form of point clouds that are too sparse or low density to create a two-dimensional intensity image of sufficient resolution to detect and match features also captured by an optical sensor. To addresses this, system 100 may accumulate intensity calibration data at step 136 while the vehicle to which the LiDAR sensor is mounted is slowly moving forward thereby densifying data to the point that it may form the basis of sufficiently high resolution intensity images. System 100 may accomplish this by registering the data accumulated to an initial or final intensity calibration data frame captured before or after the accumulation period using an iterative closest point algorithm or a variant thereof. To register each LiDAR scan to an initial or final data frame, thereby forming a reference frame, system 100 may rotate and/or translate the intensity calibration data or point cloud corresponding to each LiDAR scan to the reference frame by employing an iterative closest point algorithm to minimize the distance between all points in a particular LiDAR scan and the reference frame. In so doing, system 100 may increase the density of the of the intensity calibration data while minimizing errors arising due to motion of the vehicle during the one or more seconds of data accumulation. To ensure the reference frame of intensity calibration data is temporally synchronized to corresponding optical calibration data (which for example may be produced or timestamped at a different frequency than the intensity calibration data), system 100 may the vehicle to be stationary before or after the accumulation period in order to create the reference frame of intensity calibration data and a corresponding and synchronized optical calibration data frame without introducing the complexity of vehicle motion.

Following optional preprocessing of intensity calibration data in the form of accumulation or densification of calibration data at step 136, system 100 may next project one or more portions of the intensity calibration data that may correspond to the one or more extracted optical images onto one or more optical image planes that may also correspond to and match the field-of-view of the one or more extracted optical images thereby forming one or more intensity images at step 138. To project each point of three-dimensional intensity data or point cloud data onto the one or more optical image planes of the one or more optical images, at step 137, system 100 may first produce an estimate of the alignment between LiDAR sensor 130 and optical sensor 110, for example the transformation, or rotation and/or translation, necessary to align the LiDAR sensor coordinate system with that of the optical sensor or the particular optical image plane that the intensity calibration data may be projected onto. Such an estimate may be based, for example, on the designed orientation and position of each sensor on the vehicle to which both are attached, or on measurements made prior to commencing the calibration, etc. If the optical image plane onto which the intensity calibration data may be projected is a rotated view or virtual camera as discussed above, the estimate may be further based on the orientation of the rotated view within the optical sensor coordinate system, for example, it may be based on the rotation about the vertical axis corresponding to the rotated view.

This alignment estimate in the form of a LiDAR sensor to optical sensor transformation may then be used to modify the one or more portions of the intensity calibration data corresponding to the one or more extracted optical images. For example if LiDAR sensor 130 includes rotation, thereby producing intensity calibration data with 360-degree coverage, the relevant portions of data from each LiDAR scan may correspond to periods during which LiDAR sensor 130 was oriented in approximately the same direction as optical sensor 110 and thus detecting a similar range of external objects. Thus, the transformation matrix, incorporating the rotation and/or translation necessary to bring the LiDAR sensor 130 and optical sensor 110 into alignment based on the estimate of alignment between the two sensors, may be used to transform the relevant portion of the intensity calibration data from the coordinate system of the LiDAR sensor 130 to that of the optical sensor 110. System 100 may then use the intrinsic matrix of the optical sensor or virtual camera, including internal spatial parameters of the sensor such as focal length and optical center location, to project each point in the three-dimensional intensity calibration data onto the optical image plane associated with each optical image, thereby forming each of the one or more intensity images.

In addition to intensity information, as described above, three-dimensional intensity calibration data 132 from LiDAR sensor 130 may include depth information, i.e. the distance of detected objects from the sensor, that corresponds to each pixel of intensity information. This depth information may be used to form a depth buffer, or depth information at each pixel of the projected intensity image. This depth buffer may be useful in situations in which an object is occluded in the view of optical sensor 110 but not in the view of LiDAR sensor 130, for example resulting from differences in position and orientation of the two sensors. For example, with one object occluding another in one or more optical images but not in one or more intensity images or in one or more intensity images but not in one or more optical images, the depth buffer can detect the mismatched depth of the occluded feature during the alignment computation process described below. This depth information may also be used during final computation of the alignment between the optical sensor and LiDAR senor by associating two-dimensional intensity information with the original three-dimensional LiDAR data point.

To illustrate the optical and intensity data processing steps described thus far, for example, optical image 212 in FIG. 2 may correspond to virtual image extracted from optical calibration data 210 by optionally applying one or more lens distortion correction algorithms before projecting the data onto a rotated view or virtual camera corresponding to a rotation of 55 degrees about the vertical axis of optical sensor 110. Thus, to produce an intensity image similar to optical image 212 using intensity calibration data 112, system 100 may first isolate a portion of the data that corresponds to the period during which LiDAR sensor 130 is oriented in the direction of the rotated view corresponding to optical image 212. Next, the system may transform that isolated portion of intensity data from the coordinate system of the LiDAR sensor to that of the optical sensor using a transformation matrix based on an estimate of the alignment between the LiDAR sensor and optical sensor and accounting for the 55 degree rotation about the vertical axis used to form the rotated view of image 212. Finally, with the intensity data in the coordinate system of the optical sensor, system 100 may then use the intrinsic matrix of the optical sensor or virtual camera to project each datapoint onto the image plane of image 212, thereby forming an intensity image that corresponds to extracted optical image 212 shown in FIG. 2.

At step 140, system 100 may remove one or more segments from the intensity range of the one or more intensity images. In many LiDAR systems, laser emissions reflect off surfaces that scatters the emissions in a uniform manner, thereby returning to a LiDAR sensor a fraction of the emitted intensity. These Lambertian surfaces may include, for example, concrete sidewalks and asphalt roads and have digital intensity values ranging from 0 to 100. Retroreflective surfaces designed to reflect light to its source while minimizing scattering, thereby returning significantly higher intensity light to a LiDAR sensor than Lambertian surfaces. Examples of retroreflective surfaces include road signs and lane markings, with intensity ranges at the upper limit of a byte used to store individual intensity calibration data points, ranging from 200 to 255. By removing one or more segments, for example the segment corresponding to intensity values from 100 to 200, and redistributing intensity values over the new range by applying a histogram equalization to the remaining segments, for example 0 to 100 and 200 to 255, system 100 may reduce the spread in intensity measurements and normalize the distribution of intensity values in resulting intensity images. This smaller range of intensity values may thereby increase contrast and allow lower reflectance features to be detected, which in turn may enable higher accuracy alignment computations.

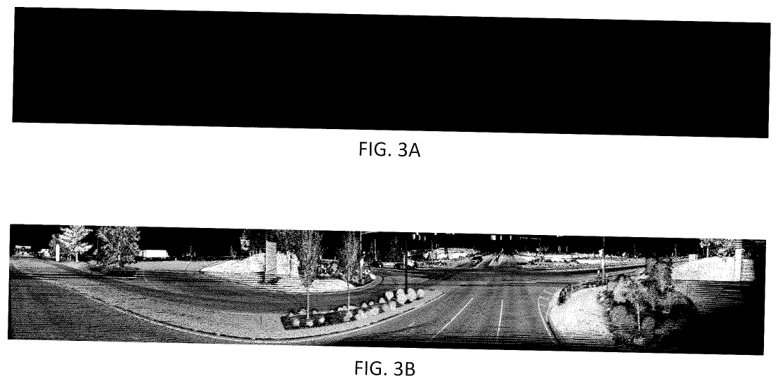

For example, FIG. 3A depicts an example of an intensity image the system may form prior to removal of the segment of the intensity range, for example between 100 and 200, and application of a histogram equalization to the remaining segments. Given that the majority of surfaces reflecting laser emissions are Lambertian and thus correspond to intensity values between 0 and 100, the intensity value of each pixel as a proportion of the maximum intensity, 255, is relatively low translating to a darker image with poor contrast. FIG. 3B depicts an example of an the same intensity image that the system may form following removal of a segment of the intensity range, for example between 100 and 200, and application of a histogram equalization. By combining Lambertian surface reflection values (0 to 100) with retroreflective surface values (200 to 255), the maximum intensity value is reduced from 255 to 155 thereby improving the contrast between various detected features and the background. This improved contrast in turn may allow a greater number of features to be detected during the alignment computation process described below.

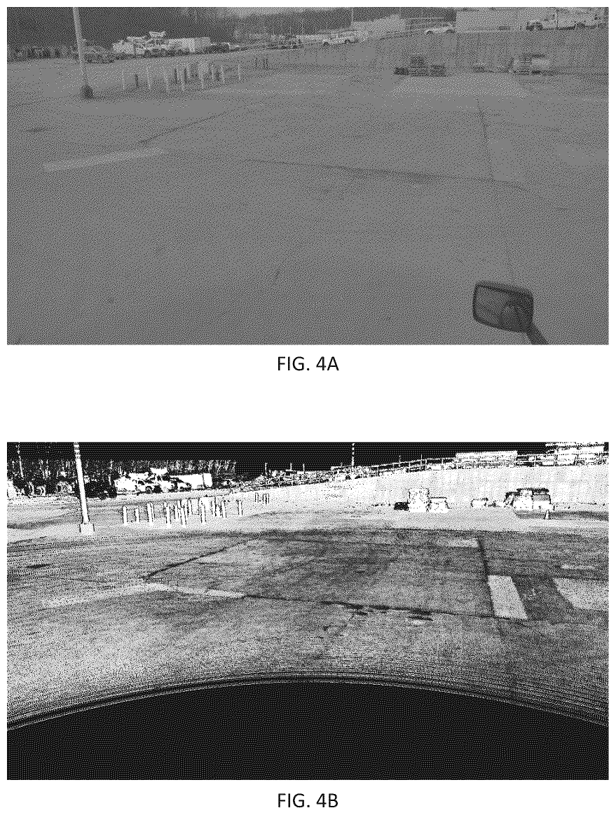

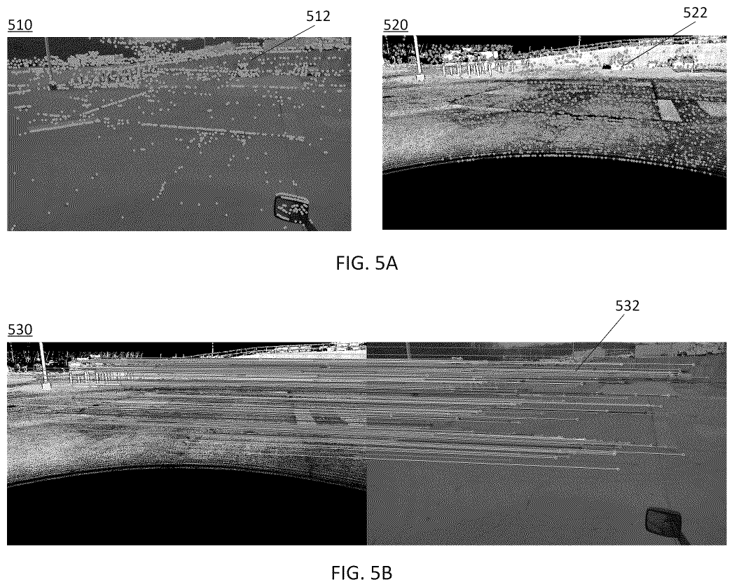

Following processing of optical calibration data at step 114 and intensity calibration data at step 134, the system may have one or more extracted optical images and one or more intensity images corresponding to each optical image, aligned based on an estimate of the position and orientation of each sensor. An example of one such pairing of an extracted optical image with an intensity image, depicting the same surroundings of a vehicle, are shown in FIGS. 4A and 4B respectively. System 100 may thus process optical calibration data to form one or more optical images with reduced or absent lens distortion and processes three-dimensional intensity calibration data by projecting each point of the data onto the one or more optical image planes of the one or more optical images thereby matching the projection and field-of-view of the optical images. By creating pairs of low-distortion images with overlapping fields-of-view, system 100 may enable use of a wider range of detector and matcher networks that may detect and produce more pairs of features necessary for calibration than if optical and intensity images were left unprocessed, possibly with differences in projection and field-of-view.

These feature detector and matcher networks may be used at step 150 to generate data necessary to compute the calibration or alignment between optical sensor 110 and LiDAR sensor 130, e.g. the rotation and/or translation necessary to bring one sensor into alignment with the other. At step 152, one or more feature detectors and descriptors may be used to detect two sets of points, a first set in the one or more intensity images and a second set in the one or more optical images, that corresponding environmental features surrounding the vehicle and within the field-of-view of the sensors. Said environmental features could include, for example, features or points corresponding to sidewalks, trees, road signs, building facades, mailboxes, or other natural environmental features that may be present in the vicinity of an autonomous or semi-autonomous vehicle. For example, in FIG. 5A, an exemplary first set of detected points corresponding to features in intensity image 510 is depicted, including point 512. An exemplary second set of detected points corresponding to features in optical image 520 is also depicted, including point 522. In the event more than one optical image was extracted, for example images 212, 214, and 216 in FIG. 2 the second set of detected points would include detected points from each of FIGS. 212, 214, and 216, e.g. including detected points from all available optical images.

One or more feature detectors and descriptors used to create each set of points corresponding to environmental features may be based on machine learning algorithms such as neural networks. Said networks may have been trained on datasets including images with known features in a wide variety of environmental conditions that may include those that may surround an autonomous or semi-autonomous vehicle. A network may first detect one or more points of interest or keypoints in an image and optionally generate one or more feature descriptors, or vectors representing the portions of the image including and surrounding each point of interest. To accomplish this feature detection and description step, system 100 may use lightweight detector and descriptors that may be based on convolution neural networks, such as ALIKED, SuperPoint, D2-Net, and/or R2D2. In some implementations, system 100 may tailor the settings of the one or more chosen networks based on environmental conditions or based on sensing modality, for example optical images and intensity images may correspond to different branches of the convolutional network. For example, feature detection and description for optical images may include sensitivity to feature texture while feature detection and description for intensity images may be more focused on detecting geometrical features in the reflected data. In other implementations an integrated approach may be taken, detecting features using a combination of the above approaches in both optical and intensity images. System 100 may setup the one or more feature detectors and descriptors based additionally on the distribution and number of located features, given that numerous well-spread detected features may improve the quality of matches between features of different images which may in turn improve the accuracy of the computed calibration or alignment.

Following detection of the first and second set of points, system 100 may at step 154 create a plurality of pairings wherein each pair of the plurality of pairings may include a point from the first set of points and a point from the second set of points. The objective of step 154 may be to create pairings in which each point of the pair of points corresponds to the same environmental feature. For example, in FIG. 5A, point 512 corresponds to a portion of wall feature in the scene surrounding the vehicle while point 522 corresponds to the same feature or a feature proximate to the feature corresponding to point 512. These pairs of detected features may be visualized as in image 530 of FIG. 5B which depicts image 512 next to image 520, and with lines connecting pairings each formed of one point from the first set of points in intensity image 510 and another point from the second set of points in optical image 520. To accomplish matching, system 100 may use a feature matcher that may, like the feature detectors and descriptors, be based on machine learning algorithms such as convolutional neural networks, here with the purpose of matching detected features of keypoints thereby generating pairings or correspondences. The feature matcher network may be trained to predict whether pairs of features correspond to each other by first taking as an input feature descriptors corresponding to each feature and applying processes such as attention mechanisms to identify features most likely to yield accurate pairings. Possible feature matchers that system 100 may use include LightGlue, SuperGlue, Brute Force Matching, and/or Fast Library for Approximate Nearest Neighbor. By computing and basing alignment computations on a plurality of pairings, system 100 may thereby improve computational efficiency by focusing on a representative set of points that may be likely to produce an alignment in agreement with other points within the one or more optical and/or intensity images.

Depth buffer information, discussed above, which may accompany intensity calibration data 132 and may indicate the distance from LiDAR sensor 130 to detected external objects, may be used during the matching process at step 154 detect occlusions, for example situations in which an object is occluded in an optical image but not in an intensity image or occluded in an intensity image but not in an optical image. In such cases, the depth information contained in the depth buffer may indicate, for example, the continuity of depth in the intensity image in the vicinity of an occluding object feature in the optical image or the change in depth of an occluding object feature in the intensity image without the occlusion present in the optical image. Information contained in the depth buffer of each intensity image therefore may be used by system 100 and/or the feature matcher specifically to ensure pairings with one detected feature occluded are not output as part of the plurality of pairings at step 154.

With a plurality of pairings between detected features in the one or more extracted optical images and the one or more intensity images created, system 100 may at step 156 proceed to compute a first alignment or candidate alignment between optical sensor 110 and LiDAR sensor 130. This first alignment may be based on a subset of the plurality of pairings. For example, system 100 may use a subset of six pairings to compute the alignment, or the transformation (e.g., rotation and/or translation) required to bring LiDAR sensor 130 into alignment with optical sensor 110. System 100 may accomplish this using a Perspective-n-Point solver based on direction vectors or bearing vectors, and may specifically use the bearing-3D point formulation of the Perspective-n-Point problem. By using bearing vectors instead of positions of pixels in the original image plane, system 100 may simultaneously compute alignment solutions based on data from a plurality of extracted optical images.

To use this bearing-3D point formulation, system 100 may first convert the point corresponding to an optical image in each pairing of the plurality of pairings to a direction vector or bearing vector based on the pixel location of the feature in the image plane, any rotation used to form the optical image, and/or the optical sensor's or virtual camera's intrinsic matrix, including parameters such as focal length and/or optical center location. System 100 may then convert the point corresponding to an intensity image in each pairing of the plurality of pairings to its corresponding three-dimensional intensity datapoint based on depth information stored in the depth buffer as described above. System 100 may then select a subset of the pairings, including the bearing vector and three-dimensional intensity datapoint associated with each pairing in the subset, and apply the bearing-3D point formulation to compute, based on the bearing vectors and the direction of the three-dimensional intensity datapoints of the subset, a first alignment, e.g. the rotation and/or translation that best aligns vectors corresponding to the directions of the three-dimensional intensity datapoints of the subset with their corresponding bearing vectors. System 100 may select the subset of pairings on a random basis or may use information from the feature matcher network to select pairings with a higher probability of producing an alignment that agrees with a significant percentage of the pairings. System 100 may convert the points corresponding to the intensity image before those corresponding to the optical image, or may convert on a pairing-by-pairing basis, or subset-by-subset basis.

To evaluate the first alignment at step 170, system 100 may apply the rotation and/or translation associated with the first alignment to the three-dimensional intensity datapoints of each pairing of the plurality of pairings. Given that the bearing-3d point formulation uses angular variables in place of pixels, the angle between the vector corresponding to a three-dimensional intensity datapoint transformed based on the first alignment and its corresponding bearing vector may be computed for each pairing of the plurality of pairings. System 100 may then use, for example, a Random Sample Consensus process to quantify agreement between the first alignment created using the subset of pairings and all pairings of the plurality of pairings. Processes that system 100 may use as an alternative to or in addition to a Random Sample Consensus process, may include, for example, a maximum consensus process, a least median of squares process, and/or an M-estimation process. To quantify agreement between the first alignment and all pairings, system 100 may compare the computed angle associated with each pairing to an agreement criteria, for example an angular alignment threshold based on a maximum desired distance in pixel units and the focal length of the optical sensor or virtual camera used to form the optical image associated with each pairing. For example, a maximum desired distance in pixel units may be less than ten pixels, less than five pixels, less than three pixels, and/or less than one pixel.

Inliers, or pairings that meet the agreement criteria or have angles less than the angular alignment threshold for example, may be summed and may represent the number of pairings that satisfy agreement criteria with respect to the first alignment. At step 174, system 100 may determine that the ratio between the number of pairings satisfying the agreement criteria with respect to the first alignment and the total number of pairings meets or exceeds a pairing threshold. In this case, system 100 may determine that the first alignment is sufficiently representative of the plurality of pairings and allow the alignment evaluation process to proceed. However, if system 100 determines the ratio between the number of pairings satisfying the agreement criteria with respect to the first alignment and the total number of pairings does not meet the pairing threshold, the process of computing an alignment based on a subset of a plurality of pairings at step 156 and evaluation of agreement among the plurality of pairings with that alignment at step 170 may be repeated until an alignment corresponding to a ratio of agreeing to total pairings that meets the pairing threshold is found.

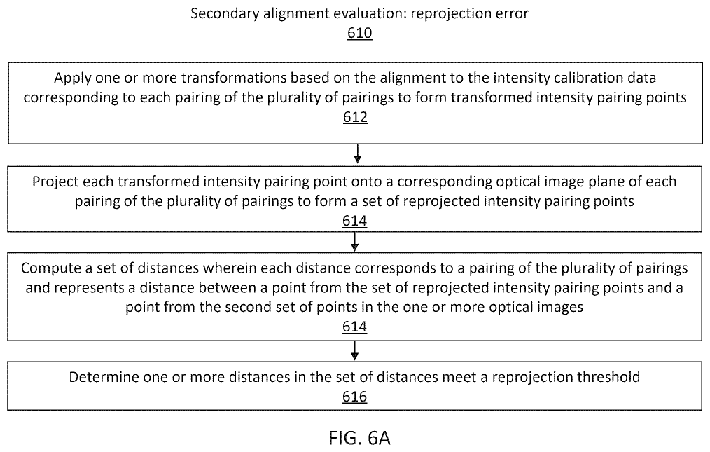

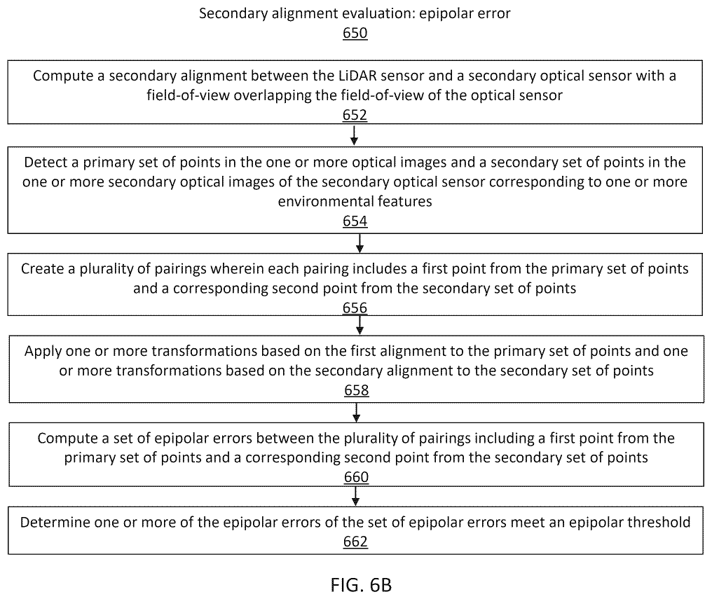

Once an alignment has been computed that agrees with a proportion of the total pairings that meets or exceeds the pairing threshold, system 100 may further evaluate the alignment using one or more secondary alignment evaluation processes at step 174 to independently confirm alignment accuracy. These processes may include computation of reprojection error 610 depicted in FIG. 6A and computation of epipolar error 650 depicted in FIG. 6B.

Measurement of reprojection error may represent one method of determining the accuracy of the alignment, i.e. rotation and/or translation, between optical sensor 110 and LiDAR sensor 130. The measurement may involve, for each pairing, applying the computed rotation and/or translation to the three-dimensional intensity datapoint of the pairing before projecting the datapoint onto the image plane of containing the corresponding optical datapoint of the pairing to measure the distance between the two datapoints. Specifically, measurement of reprojection error 610 may include, at step 612, first applying one or more transformations, which may include the rotation and/or translation computed based on the first alignment or the alignment selected at step 174 as associated with a ratio meeting the pairing threshold, to the intensity calibration data corresponding to each pairing of the plurality of pairings. That is, the set of points from the first set of points in the one or more intensity images that system 100 selected to be paired with corresponding points in the second set of points in the one or more optical images, or intensity pairing points, may be expressed as three-dimensional points based on depth information stored in the depth buffer as discussed above. Once expressed as three-dimensional points, the vectors representing the direction of these three-dimensional points may be transformed, based on the rotation and/or translation of the alignment to be evaluated, from the coordinate system of LiDAR sensor 130 to that of optical sensor 110, thereby forming transformed intensity pairing points.

At step 614, for each pairing, system 100 may project, or reproject, each transformed intensity pairing point onto the optical plane of the optical image containing the corresponding optical pairing point, based on the intrinsic matrix of the optical sensor or virtual camera as discussed above, thereby forming reprojected intensity pairing points. By reprojecting the three-dimensional intensity pairing point of each pairing onto the image plane containing the corresponding optical point of the pairing, e.g. the point selected from the second set of points in the one or more optical images, system 100 may ensure the distance between the intensity and optical points of each pairing can be computed as an indication of alignment accuracy.

At step 614, for each pairing, system 100 may compute the distance, optionally the Euclidean distance measured in pixels, between the point of the pairing in the set of reprojected intensity pairing points and the corresponding point of the pairing in the second set of points in the one or more optical images, thereby forming a set of distances that may be referred to as reprojection error.

System 100 may determine one or more distances of the set of distances meet a reprojection threshold. For example, system 100 may determine that a portion of the distances or all of the distances of the set of distances are lower than a pixel value corresponding to the reprojection threshold and use this portion in combination with the chosen reprojection threshold as an indication of alignment accuracy.

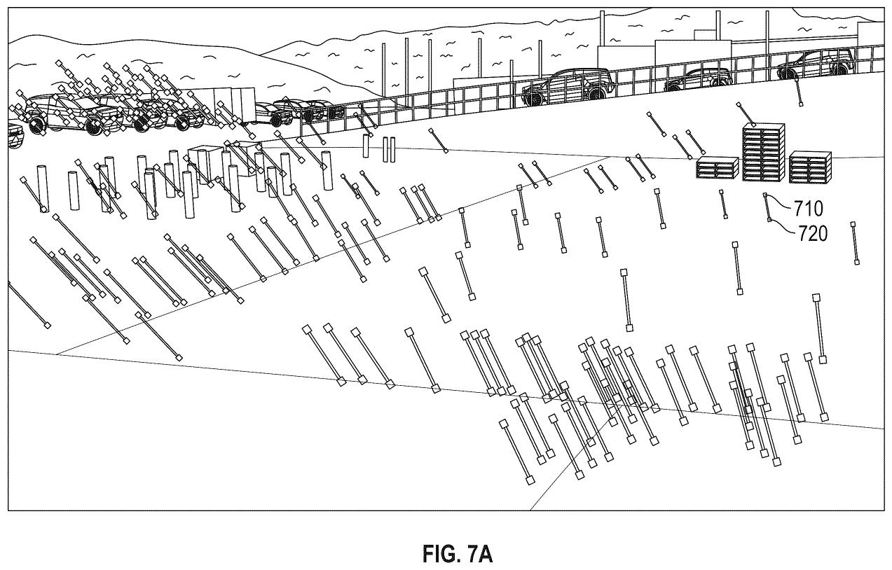

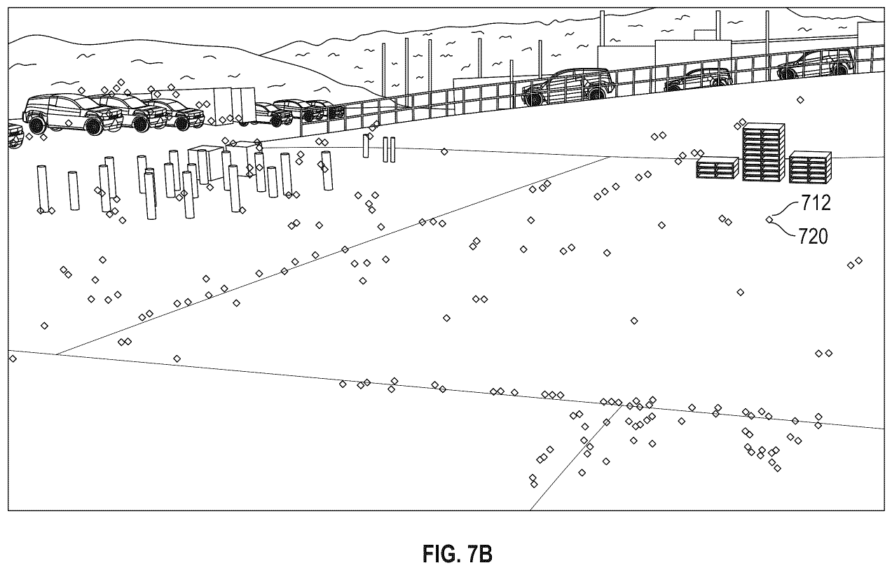

The effect of the alignment process depicted in FIG. 1C may be visualized by comparing the reprojection error associated with the estimate of calibration or alignment that system 100 may have generated at step 137, with the reprojection error associated with the final alignment. To visualize the initial reprojection error, for each pairing, the intensity image generated at step 138 containing the intensity pairing point may be overlaid on the optical image generated at step 118 containing the optical pairing point thereby enabling the distance between the two points, e.g. the Euclidean distance, or reprojection error to be computed. For example, FIG. 7A depicts the extracted optical image depicted in FIG. 4A and with a set of pairings in FIG. 5B. FIG. 7A depicts the intensity pairing points (e.g. the points on the left side of image 530 of FIG. 5B) overlaid on the optical pairing points (e.g. the points on the right side of image 530). For example, point 720 may depict an optical pairing point that corresponds to intensity pairing point 710, with the line connecting the two representing the distance between the two points making up the set of distances representing the reprojection error of the estimated calibration or alignment.

To visualize the final reprojection error, process 610 as described above may be applied. FIG. 7B corresponds to the same pairings as in FIG. 7A, however the intensity points have been transformed by a rotation and/or translation that corresponds to the first alignment or final alignment, e.g. the alignment selected at step 174 as associated with a ratio meeting the pairing threshold, and projected back onto the optical image plane to form reprojected intensity pairing points. FIG. 7B thus depicts the same extracted optical image and the same optical pairing point 720 of the pairing, however the corresponding intensity point of the pairing has been transformed and reprojected as discussed above to become reprojected intensity pairing point 712. Points 712 and 720 and indeed all pairing points depicted in FIG. 7B are now proximate to a degree that it may be difficult to discern the reprojection error, or the distances between them.

With more than one optical sensors, system 100 may additionally or alternatively evaluate alignment by computing the epipolar error. The measurement may involve first following the process depicted in FIG. 1C to compute the alignment between the LiDAR sensor and an optical sensor before repeating the process to compute a secondary alignment between the LiDAR sensor and a secondary optical sensor with a field-of-view overlapping that of the optical sensor. Specifically, measurement of epipolar error 650 may include, at step 652, first computing the secondary alignment between the LiDAR sensor and the secondary optical sensor before detecting, at step 654, a primary set of points in the one or more optical images and a secondary set of points in the one or more secondary optical images of the secondary optical sensor corresponding to one or more environmental features. Next, at step 656, a plurality of pairings may be created wherein each pair may be composed of first point from the primary set of points and a corresponding second point from the secondary set of points. The objective of step 656 as with step 154 may be to create pairings in which each point of the pair of points corresponds to the same environmental feature. The feature detectors and descriptors as well as the feature matchers, discussed above in the context of step 150 of the process depicted in FIG. 1C, including those based on machine-learning algorithms such as neural networks, may be used to detect, describe, and pair points corresponding to the same type of environmental features in the scene surrounding the vehicle to which the two optical sensors and LiDAR sensor may be mounted.

System 100 may then, at step 658, apply one or more transformations, which may include the rotation and/or translation corresponding to the final alignment computed between the LiDAR sensor and the optical sensor, optionally including the first alignment, to the primary set of points. System 100 may also apply one or more transformations, which may include the rotation and/or translation corresponding to the final alignment computed between the LiDAR sensor and the secondary optical sensor to the secondary set of points. As mentioned above, the final alignment may correspond the alignment selected at step 174 as associated with a ratio meeting the pairing threshold. To accomplish this transformation, the alignment matrix that was used, for example at step 170 to transform from the coordinate system of the LiDAR sensor to that of the optical sensor, may be inverted to enable transformation from the coordinate system of the optical sensor to that of the LiDAR sensor.

Next, at step 660, system 100 may compute a set of epipolar errors between the plurality of pairings which each may include a first point from the primary set of points and a corresponding second point from the secondary set of points. Computation of the set of epipolar errors between points of the two sets of points may include first computing a fundamental matrix and/or essential matrix based on one or more of the pairings of the plurality of pairings and the intrinsic matrix of each optical sensor or virtual camera used to form the optical images and secondary optical images corresponding to each pairing. This fundamental matrix and/or essential matrix may be used to compute epipolar lines that may represent the projection or mapping onto the optical image of one sensor of a pairing point corresponding to the other optical sensor.

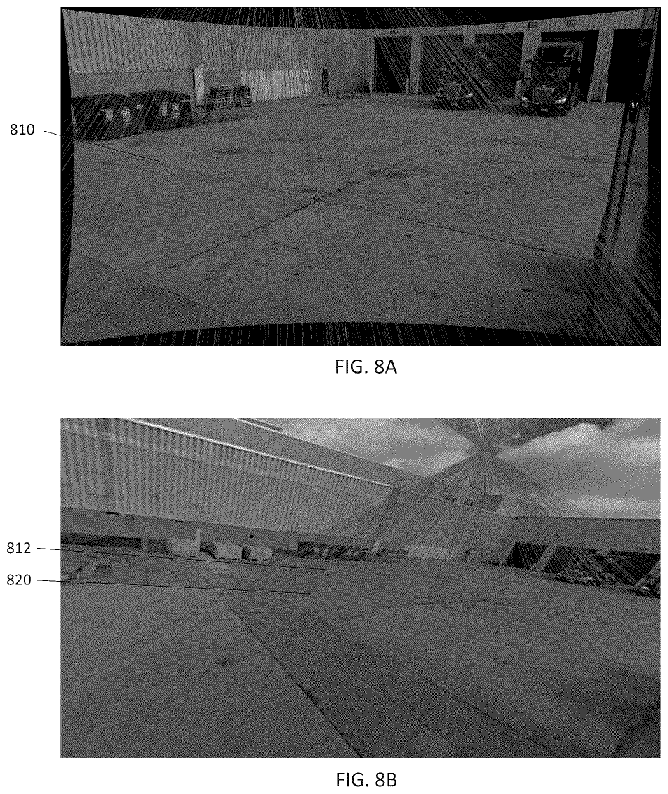

For example, optical images corresponding to two optical sensors, with overlapping fields-of-view and with paired points that have been transformed to the coordinate system of the same LiDAR sensor, are depicted in FIGS. 8A and 8B. Point 810 in FIG. 8A and point 812 in FIG. 8B may correspond to the same environmental feature and together may form a pairing of points. Thus, epipolar line 820 may represent the projection of point 810 in FIG. 8A corresponding to one optical sensor onto the optical image depicted in FIG. 8B corresponding to the other optical sensor and thus form the epipolar line corresponding to point 812. Finally, to compute a set of epipolar errors between the plurality of pairings, the distance between each of one or more pairing points and its corresponding epipolar line, which be a pixel value measured perpendicularly from the epipolar line, may be computed for each image.

At step 662, system 100 may determine that one or more epipolar errors of the set of epipolar errors corresponding to each optical image meet an epipolar threshold. For example, system 100 may determine that a portion of the epipolar errors or all of the epipolar errors of the set of epipolar errors are lower than a pixel value corresponding to the epipolar threshold and use this portion in combination with the chosen epipolar threshold as an indication of alignment accuracy.

Returning to FIG. 1C, following evaluation of alignment at step 170 including the above optional means of secondary alignment evaluation, system 100 may apply transformations based on the first alignment, or a final alignment that associated with a ratio meeting the pairing threshold, to data subsequently used for vehicle control, including the optical data produced by image sensor 110 and/or the intensity data produced by LiDAR sensor 130. In so doing, system 100 may apply one or more rotations and/or translations based on the determined calibration or alignment between one or more optical and/or LiDAR sensors thereby enabling the vehicle to which the sensors are mounted to fuse sensor data and obtain enhanced information about its surroundings, including the depth of external objects and views of objects from multiple points while reducing errors due to sensor miscalibration or misalignment.

In one or more examples, the disclosed systems and methods utilize or may include a computer system. FIG. 9 depicts an exemplary computing system according to one or more examples of the disclosure. Computer 900 can be a host computer connected to a network. Computer 900 can be a client computer or a server. As shown in FIG. 9, computer 900 can be any suitable type of microprocessor-based device, such as a personal computer, workstation, server, or handheld computing device, such as a phone or tablet. The computer can include, for example, one or more of processor 910, input device 920, output device 930, storage 940, and communication device 960. Input device 920 and output device 930 can correspond to those described above and can either be connectable or integrated with the computer.

Input device 920 can be any suitable device that provides input, such as a touch screen or monitor, keyboard, mouse, or voice-recognition device. Output device 930 can be any suitable device that provides an output, such as a touch screen, monitor, printer, disk drive, or speaker.

Storage 940 can be any suitable device that provides storage, such as an electrical, magnetic, or optical memory, including a random-access memory (RAM), cache, hard drive, CD-ROM drive, tape drive, or removable storage disk. Communication device 960 can include any suitable device capable of transmitting and receiving signals over a network, such as a network interface chip or card. The components of the computer can be connected in any suitable manner, such as via a physical bus or wirelessly. Storage 940 can be a non-transitory computer-readable storage medium comprising one or more programs, which, when executed by one or more processors, such as processor 910, cause the one or more processors to execute methods described herein.

Software 950, which can be stored in storage 940 and executed by processor 910, can include, for example, the programming that embodies the functionality of the present disclosure (e.g., as embodied in the systems, computers, servers, and/or devices as described above). In one or more examples, software 950 can include a combination of servers such as application servers and database servers.

Software 950 can also be stored and/or transported within any computer-readable storage medium for use by or in connection with an instruction execution system, apparatus, or device, such as those detailed above, that can fetch and execute instructions associated with the software from the instruction execution system, apparatus, or device. In the context of this disclosure, a computer-readable storage medium can be any medium, such as storage 940, that can contain or store programming for use by or in connection with an instruction execution system, apparatus, or device.

Software 950 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include but is not limited to, an electronic, magnetic, optical, electromagnetic, or infrared wired or wireless propagation medium.

Computer 900 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 900 can implement any operating system suitable for operating on the network. Software 950 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

1. A sensor calibration system of a vehicle, the calibration system comprising:
an optical sensor configured to generate two-dimensional optical calibration data;
a LiDAR sensor configured to generate three-dimensional intensity calibration data; and
one or more computer-readable media storing instructions that, when executed by one or more processors, cause the system to:
generate optical calibration data and intensity calibration data;
extract one or more optical images from the optical calibration data;
project one or more portions of the intensity calibration data onto one or more optical image planes corresponding to the one or more optical images to form one or more intensity images;
detect a first set of points in the one or more intensity images and a second set of points in the one or more optical images corresponding to one or more environmental features;
create a plurality of pairings wherein each pairing comprises a first point from the first set of points and a corresponding second point from the second set of points; and
compute an alignment between the optical sensor and the LiDAR sensor based on a subset of the plurality of pairings.

2. The calibration system of claim 1, wherein generating the intensity calibration data further comprises accumulating one or more seconds of intensity calibration data while the vehicle is in motion.

3. The calibration system of claim 2, wherein accumulating one or more seconds of intensity calibration data comprises aligning, using an iterative closest point algorithm, the one or more seconds of intensity calibration data with a portion of the intensity calibration data captured before or after the one or more seconds of accumulation.

4. The calibration system of claim 1, wherein generating the intensity calibration data further comprises removing one or more segments from an intensity range of the intensity calibration data and performing histogram equalization on the intensity calibration data following removal of the one or more segments from the intensity range.

5. The calibration system of claim 1, wherein projecting the one or more portions of intensity calibration data onto the one or more optical image planes is based on an estimated alignment between the optical sensor and the LiDAR sensor.

6. The calibration system of claim 1, wherein forming the one or more intensity images comprises matching a field-of-view of the corresponding one or more optical images.

7. The calibration system of claim 1, wherein projecting the one or more portions of intensity calibration data comprises generating depth information for one or more datapoints of the one or more intensity images.

8. The calibration system of claim 1, wherein extracting one or more optical images from the optical calibration data comprises rotating two or more portions of the optical calibration data about a vertical axis of the optical sensor.

9. The calibration system of claim 1, wherein extracting one or more optical images further comprises reducing lens distortion in the optical calibration data.

10. The calibration system of claim 1, wherein the first point and the second point of each pairing of the plurality of pairings correspond to a common environmental feature of the one or more environmental features, and wherein each pairing was generated using one or more feature-matching machine-learning algorithms.

11. The calibration system of claim 7, wherein creating the plurality of pairings comprises determining, based on the depth information, that an environmental feature of the one or more environmental features is occluded in at least one of: the one or more optical images or the one or more intensity images, and excluding one or more pairings from the plurality of pairings based on the determination.

12. The calibration system of claim 1, wherein computing the alignment between the optical sensor and the LiDAR sensor comprises using a Perspective-n-Point solver based on direction vectors.

13. The calibration system of claim 1, wherein the one or more optical images comprise two or more optical images, and wherein the subset of the plurality of pairings is based on points in each of the two or more optical images.

14. The calibration system of claim 1, wherein the instructions further cause the system to determine a number of the plurality of pairings that satisfy one or more agreement criteria with respect to the alignment using Random Sample Consensus.

15. The calibration system of claim 14, wherein the instructions further cause the system to determine that a ratio between the determined number of pairings that satisfy the one or more agreement criteria and a total number of pairings meets a pairing threshold.

16. The calibration system of claim 1, wherein the instructions further cause the system to:
apply one or more transformations based on the alignment to the intensity calibration data corresponding to each pairing of the plurality of pairings to form transformed intensity pairing points; and
project each transformed intensity pairing point onto a corresponding optical image plane of each pairing of the plurality of pairings to form a set of reprojected intensity pairing points.

17. The calibration system of claim 16, wherein the instructions further cause the system to compute a set of distances wherein each distance corresponds to a pairing of the plurality of pairings and represents a distance between a point from the set of reprojected intensity pairing points and a point from the second set of points in the one or more optical images.

18. The calibration system of claim 17, wherein the instructions further cause the system to determine that one or more distances in the set of distances meet a reprojection threshold.

19. The calibration system of claim 1, wherein the alignment is a first alignment, and wherein the instructions further cause the system to compute a secondary alignment between a secondary optical sensor and the LiDAR sensor, and wherein a field-of-view of the optical sensor overlaps a field-of-view of the secondary optical sensor.

20. The calibration system of claim 19, wherein the instructions further cause the system to:
detect a primary set of points in the one or more optical images and a secondary set of points in one or more secondary optical images of the secondary optical sensor corresponding to one or more environmental features; and
apply one or more transformations based on the first alignment to the primary set of points and one or more transformations based on the secondary alignment to the secondary set of points.

21. The calibration system of claim 20, wherein the instructions further cause the system to compute a set of epipolar errors between one or more points of the primary set of points and one or more points of the secondary set of points.

22. The calibration system of claim 21, wherein the instructions further cause the system to determine that one or more of the epipolar errors in the set of epipolar errors meet an epipolar threshold.

23. The calibration system of claim 1, wherein the instructions further cause the system to apply one or more transformations based on the alignment to at least one of vehicle control optical data or vehicle control intensity data.

24. A method for calibrating sensors of a vehicle, the method performed by a system comprising memory and one or more processors, the method comprising:
generating optical calibration data and intensity calibration data;
extracting one or more optical images from the optical calibration data;
projecting one or more portions of the intensity calibration data onto one or more optical image planes corresponding to the one or more optical images to form one or more intensity images;
detecting a first set of points in the one or more intensity images and a second set of points in the one or more optical images corresponding to one or more environmental features;
creating a plurality of pairings wherein each pairing comprises a first point from the first set of points and a corresponding second point from the second set of points; and
computing an alignment between the optical sensor and the LiDAR sensor based on a subset of the plurality of pairings.

25. A non-transitory computer readable storage medium storing instructions for calibrating sensors of a vehicle, wherein the instructions, when executed by one or more processors of an electronic device, cause the device to:
generate optical calibration data and intensity calibration data;
extract one or more optical images from the optical calibration data;
project one or more portions of the intensity calibration data onto one or more optical image planes corresponding to the one or more optical images to form one or more intensity images;
detect a first set of points in the one or more intensity images and a second set of points in the one or more optical images corresponding to one or more environmental features;
create a plurality of pairings wherein each pairing comprises a first point from the first set of points and a corresponding second point from the second set of points; and
compute an alignment between the optical sensor and the LiDAR sensor based on a subset of the plurality of pairings.
